(19) United States
(12) Patent Application Publication
(10) Pub. No.: US 2011/0239952 A1
(43) Pub. Date: Oct. 6, 2011

(54) Method and Apparatus for Brooding Game Birds

(75) Inventors: Jay Merritt, Uvalde, TX (US); Bennie Molsbee, Alpine, TX (US); Jack Stone, Uvalde, TX (US)

(73) Assignee: COVEY ENTERPRISES, LLC, Uvalde, TX (US)

(21) Appl. No.: 13/077,952

(22) Filed: Mar. 31, 2011

Related U.S. Application Data
(60) Provisional application No. 61/320,811, filed on Apr. 5, 2010.

(51) Int. Cl. A01K 31/20

(52) U.S. Cl. 119/300; 119/303

(57) ABSTRACT

Methods and systems for propagating game birds are disclosed including providing a transportable game bird brooder system comprising: a trailer frame; a climate controlled containment unit attached to a first portion of the trailer frame; and an open-air containment unit attached to a second portion of the trailer frame; placing less than week old game birds into the climate controlled containment unit and providing the game birds feed and water for approximately two weeks; after the game birds reach approximately three weeks old, permitting the game birds to access the open-air containment unit and providing the game birds feed and water for approximately two additional weeks; and releasing the game birds from the transportable game bird brooder system approximately four weeks after placing the less than week old game birds into the climate controlled containment unit. Other embodiments are described and claimed.

### I. CROSS REFERENCE TO RELATED APPLICATIONS

The inventors claim priority to provisional patent application No. 61/320,811 filed on Apr. 5, 2010.

### II. BACKGROUND

The invention relates generally to the field of propagating game birds. More particularly, the invention relates to a game bird brooder system that utilizes the game birds' natural instincts for propagation and survival.

### III. SUMMARY

In one respect, disclosed is a method for propagating game birds, the method comprising: providing a transportable game bird brooder system comprising: a trailer frame comprising: a mesh flooring; one or more wheel axles attached to the trailer frame; two or more wheels attached to the one or more wheel axles; and a coupler attached to the trailer frame and configured to connect the trailer frame to a trailer hitch; a climate controlled containment unit attached to a first portion of the trailer frame, wherein the climate controlled containment unit comprises: a lid configured to cover the top of the climate controlled containment unit; a feeding station within the climate controlled containment unit configured to allow game bird access to feed; a drop-in basket within the climate controlled containment unit configured to house a heating unit; and an enclosed water system within the climate controlled containment unit configured to allow game bird access to water; an open-air containment unit attached to a second portion of the trailer frame, wherein the open-air containment unit comprises a panel door configured to allow the release of game bird from the transportable game bird brooder system; and wherein the climate controlled containment unit further comprises controllable game bird access to the open-air containment unit; placing less than week old game birds into the climate controlled containment unit and providing the game birds feed and water for approximately two weeks; after the game birds reach approximately three weeks old, permitting the game birds to access the open-air containment unit and providing the game birds feed and water for approximately two additional weeks; and releasing the game birds from the transportable game bird brooder system approximately four weeks after placing the less than week old game birds into the climate controlled containment unit.

In another respect, disclosed is an apparatus for brooding game birds, the apparatus comprising: a trailer frame comprising: a mesh flooring; one or more wheel axles attached to the trailer frame; two or more wheels attached to the one or more wheel axles; and a coupler attached to the trailer frame and configured to connect the trailer frame to a trailer hitch; a climate controlled containment unit attached to a first portion of the trailer frame, wherein the climate controlled containment unit comprises: a lid configured to cover the top of the climate controlled containment unit; a feeding station within the climate controlled containment unit configured to allow game bird access to feed; a drop-in basket within the climate controlled containment unit configured to house a heating unit; and an enclosed water system within the climate controlled containment unit configured to allow game bird access to water; an open-air containment unit attached to a second portion of the trailer frame, wherein the open-air containment unit comprises a panel door configured to allow the release of game bird from the transportable game bird brooder system; and wherein the climate controlled containment unit further comprises controllable game bird access to the open-air containment unit.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a side perspective of the propagation station, in accordance with some embodiments.

FIG. 2 is a top perspective of the base of the propagation station, in accordance with some embodiments.

FIG. 3 is a cutaway side perspective of the climate controlled containment unit of the propagation station, in accordance with some embodiments.

FIG. 4 is a top perspective of the climate controlled containment unit of the propagation station, in accordance with some embodiments.

FIG. 5 is an end perspective of the climate controlled containment unit of the propagation station, in accordance with some embodiments.

FIG. 6 is a top perspective of the lid of the propagation station, in accordance with some embodiments.

FIG. 7 is a cutaway side perspective of the open-air containment unit of the propagation station, in accordance with some embodiments.

FIG. 8 is a top perspective of the open-air containment unit of the propagation station, in accordance with some embodiments.

FIG. 9 is an end perspective of the open-air containment unit of the propagation station, in accordance with some embodiments.

FIG. 10 is a front perspective of the feed station, in accordance with some embodiments.

FIG. 11 is a cutaway side perspective of the feed station, in accordance with some embodiments.

FIG. 12 is a front perspective of the feed station, in accordance with some embodiments.

FIG. 13 is a cutaway top perspective of the feed station, in accordance with some embodiments.

FIG. 14 is a front perspective of the panels of the base of the feed station, in accordance with some embodiments.

FIG. 15 is a flow diagram illustrating a method for propagating game birds, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In some embodiments, a game bird brooder system utilizes a bird's natural survival instincts for introducing and sustaining a healthy population of game birds. The game bird brooder system comprises a propagation station followed by a feeder station. The propagation station can accommodate approximately 125-150 quail, 85 chukars, or 65 pheasants. Additionally, the propagation station is designed to be mobile and transportable to allow the brooding of game birds in different locations. The propagation station comprises a climate controlled containment unit and an open-air containment unit. Both units of the propagation station completely protect the game birds from predators. The four week brooding process begins with five days old to seven days old game birds being placed into the climate controlled containment unit. At five days old to seven days old, the game birds are past their most vulnerable age and are able to maintain themselves, thus resulting in an increased survivability rate. The climate controlled containment unit is maintained at a constant temperature with a heating system such as a propane heater placed within a drop-in basket within the climate controlled containment unit. The game birds are confined to the climate controlled containment unit for two weeks or until the game birds are three weeks of age. The climate controlled containment unit also has a feed and a water station to nourish the game birds. The feed and water stations are specialized systems which promote the natural behavior of the game birds to feed and water. To promote the game birds' natural instinct to eat in the wild, the feeding system provides feed and water at a low level. The water system is a self contained unit that dispenses water through a sealed system which decreases the spread of disease. When the game birds reach roughly three weeks of age, the brooding process continues by moving the game birds into the open-air containment unit of the propagation station.

Within the secure open-air containment unit, the game birds begin their acclimation to their natural surroundings, similar to that of the wild species. Within the open-air containment unit, the game birds are introduced to another feed and water system. After roughly two weeks in the open-air containment unit, the game birds are released from the propagation station and into a secure, penned area. The secure area is a pen made from four inch by four inch cattle panel that can be placed around the release area. After release, the propagation station is removed and a feeder station is placed approximately where the propagation station was located. The feeder station is similar in design and construction to the feed and water system of the open-air containment unit in order to sustain a healthy population of both released and wild populations of game birds.

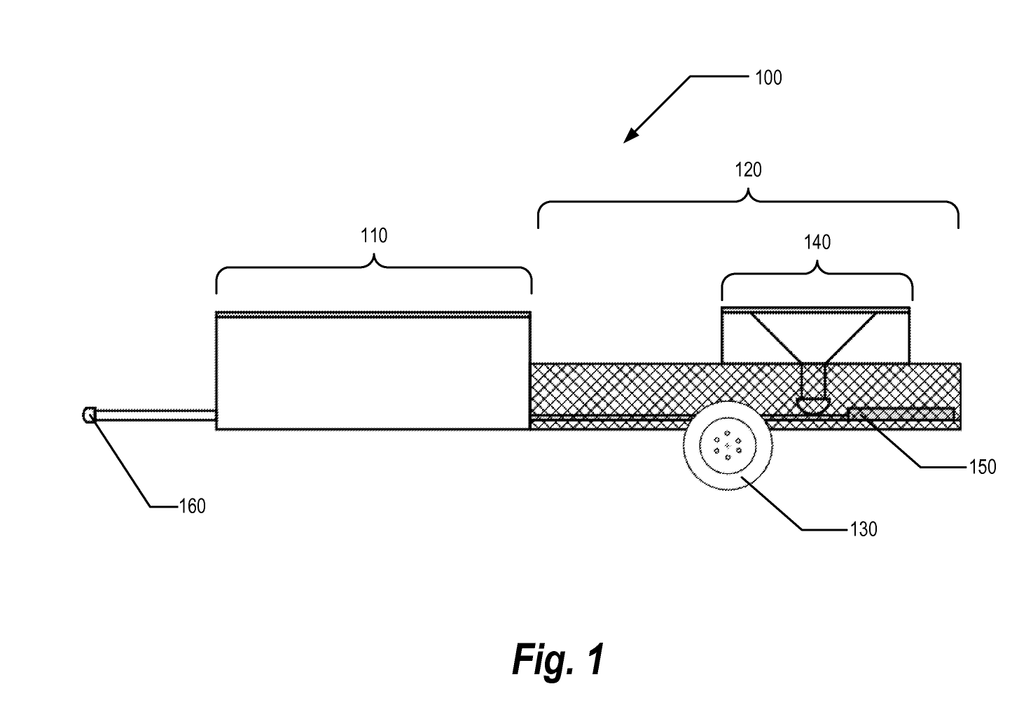

FIG. 1 is a side perspective of the propagation station, in accordance with some embodiments.

In some embodiments, the propagation station 100 is designed to be mobile and transportable. The propagation station 100 is constructed of steel and comprises a climate controlled containment unit 110 and an open-air containment unit 120 integrated together on a trailer platform with removable wheels 130. After the propagation station 100 is located where the brooding process is to be conducted, the wheels 130 are removed to allow the propagation station 100 to sit directly on the ground. A feed system and water system (not shown) are integrated within the climate controlled containment unit. Another feed system 140 and water system 150 are integrated within the open-air containment unit 120. The propagation station 100 also has a tongue or coupler 160 for attaching to a trailer hitch in order to move and transport the propagation station to another location. Additionally, the entire propagation station 100 is designed to be easy cleaning so that after the four week brooding process, the propagation station 100, if so desired, can be easily washed down in preparation for another brooding.

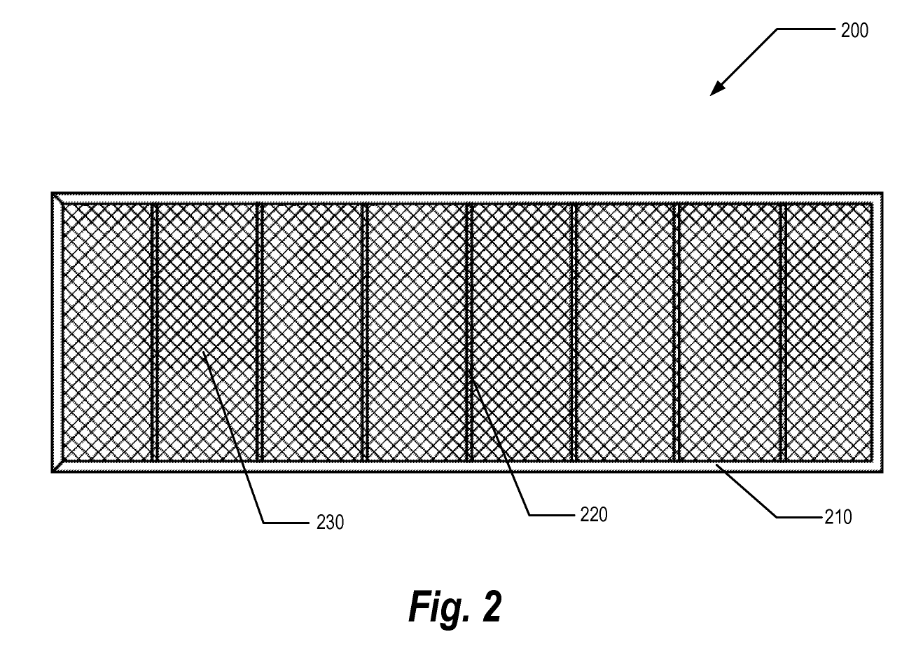

FIG. 2 is a top perspective of the base of the propagation station, in accordance with some embodiments.

In some embodiments, the propagation station is constructed on a steel base 200 which comprises a rectangular frame 210 of approximately 12 feet by 4 feet constructed from 1.5 inch square channel 10-gauge steel. The rectangular frame 210 is reinforced with seven, 0.75 inch square channel 14-guage steel 220 spaced evenly along the long dimension of the rectangular frame 210. The steel base 200 also comprises a flooring 230 constructed from a 0.25 inch mesh 14-guage steel. The steel base 200 provides sufficient rigidity and strength to allow the moving and transporting of the propagation station. Having the steel mesh flooring 230 allows the easy cleaning of the propagation station as well as permitting the game birds exposure to the ground when the wheels are removed and the propagation station is resting on the ground.

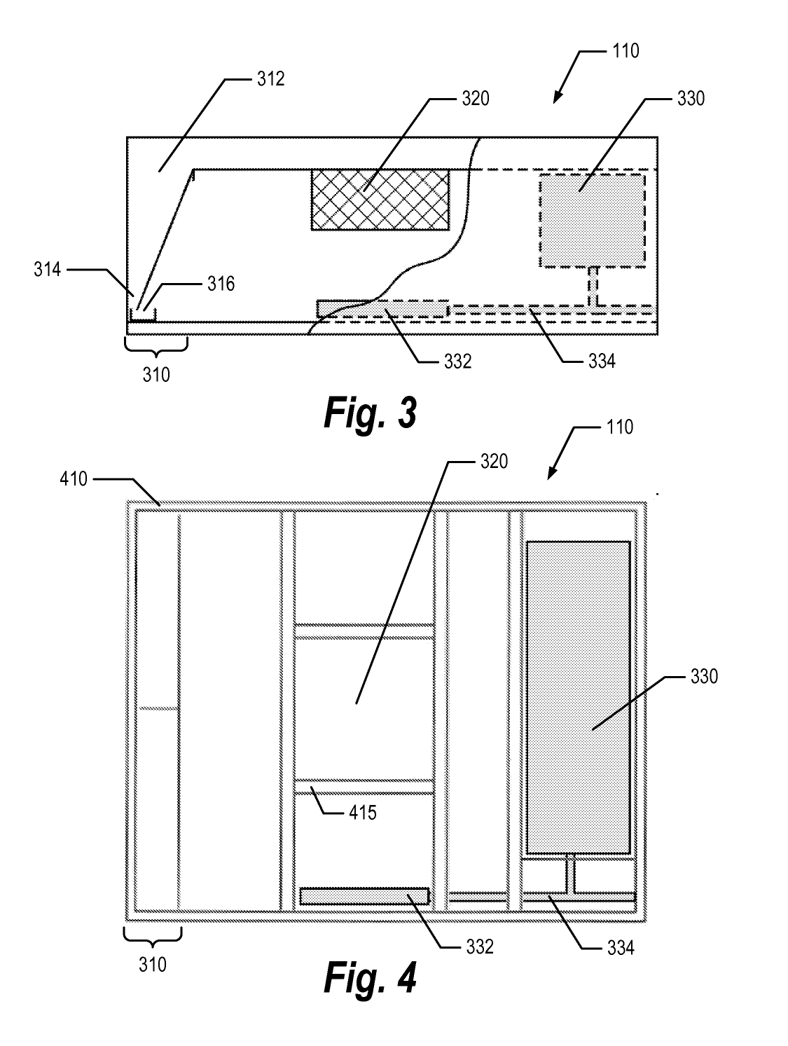

FIG. 3 is a cutaway side perspective of the climate controlled containment unit of the propagation station, in accordance with some embodiments.

In some embodiments, the climate controlled containment unit 110 of the propagation station is constructed towards the tongue end of the propagation station. The climate controlled containment unit 110 has a vertical interior height of approximately 22 inches and comprises a feeding station 310, a drop-in basket 320, and a water system or station. The feeding station 310 is formed along one of the inside walls of the climate controlled containment unit 110 and comprises a 16-gauge steel plate forming a larger opening at the top 312 and a smaller opening at the bottom 314 that opens to a 3 inch by 1 inch 16-guage channel 316 from where the game birds consume the feed. The feeding station 310 functions like a funnel where feed is added at the top 312 and then dispensed through the bottom 314 into the channel. The feed may comprise a game bird starter type feed. The drop-in basket 320 is a 16 inch square by 7 inch deep wire mesh basket centrally placed within the climate controlled containment unit and roughly 10.5 inches from the wire mesh flooring. The drop-in basket 320 provides a place for the heating unit, such as a propane heater, to efficiently heat the climate controlled containment unit 110, but still be kept away from direct contact with the game birds. Within the climate controlled containment unit 110, there is also a water station. The water station comprises a sealed water storage tank 330. Half inch tubing 334 feeds the water from the water storage tank 330 to a water feeding tube 332. The water feeding tube 332 is a 2 inch PVC pipe that has one or more nipples attached to it from where the game birds may drink. The water from the storage tank 330 is also fed into a similar water feeding tube in the open-air containment unit through the half inch tubing 334.

FIG. 4 is a top perspective of the climate controlled containment unit of the propagation station, in accordance with some embodiments.

In some embodiments, the climate controlled containment unit 110 comprises a rectangular housing of approximately 5 feet by 4 feet constructed from walls 410 of 16-gauge steel and having a one inch lip at the top of the climate controlled containment unit 110. The drop-in basket 320 is supported with 1.5 inch by 1.5 inch steel angle 415. The feed station 310 is placed against one of the side walls of the climate controlled containment unit 110. The water storage tank 330 is also accommodated within the climate controlled containment unit 110. Half inch tubing 334 feeds the water from the water storage tank 330 to the water feeding tube 332. A section of the half inch tubing 334 also feeds the water into the open-air containment unit.

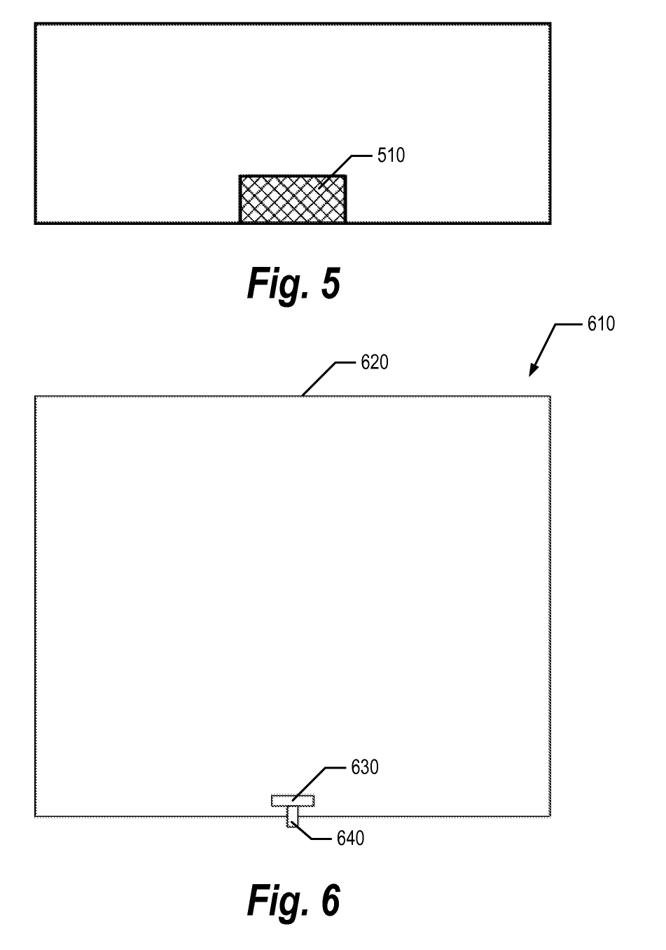

FIG. 5 is an end perspective of the climate controlled containment unit of the propagation station, in accordance with some embodiments.

In some embodiments, the wall of the climate controlled containment unit furthest from the tongue or coupler of the propagation station comprises a roughly 5 inch by 12 inch, 0.25 inch mesh access door 510. The mesh door 510 is opened after approximately two weeks of brooding in the climate controlled containment unit to move the game birds into the adjacent open-air containment unit. The mesh door 510 has a latch to lock it either in the open or closed position depending on the stage of the brooding process. In the last two weeks of the brooding process, the mesh door 510 is locked in the open position to allow the game birds to access both units, the climate controlled containment unit and the open-air containment unit.

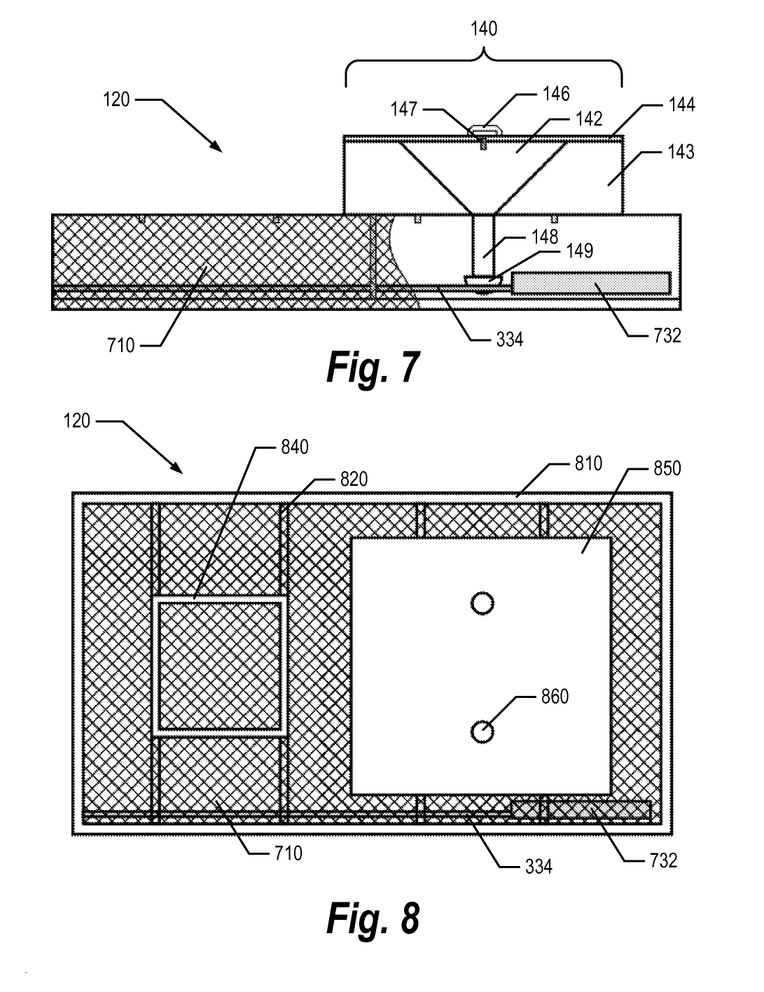

FIG. 6 is a top perspective of the lid of the propagation station, in accordance with some embodiments.

In some embodiments, the lid 610 of the propagation station is constructed from 16-gauge steel and has a hinge 620 on one side with a handle 630 and a latch 640 opposite the hinge 620. The lid 610 is approximately a quarter inch longer along the sides than the climate controlled containment unit and completely covers the climate controlled containment unit. The lid 610 is hinged along the wall that extends between the wall of the feeder station 310 to the wall of the mesh door 510. The handle 630 facilitates the opening of the lid 610 to allow access to the climate controlled containment unit. The lid 610 is held in the open position by a couple of gas or spring cylinders which allow for simpler loading of the feed and water stations along with the introduction of game birds into the climate controlled containment unit. The latch 640 allows the lid to be securely locked to the climate control unit.

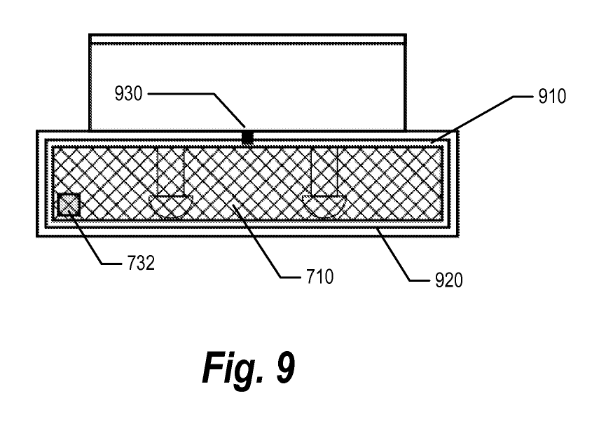

FIG. 7 is a cutaway side perspective of the open-air containment unit of the propagation station, in accordance with some embodiments.

In some embodiments, the open-air containment unit 120 of the propagation station is constructed on the back seven feet of the steel base 200 and has an interior height of 10.5 inches. The open-air containment unit 120 provides exposure of the natural surroundings to the game birds. The walls and roof of the open-air containment unit 120 are framed with 0.75 inch and 1.5 inch square channel 16-gauge steel and sided with 0.25 inch mesh 14-guage steel 710. A feeder station 140 is attached on top and into the open-air containment unit 120. Similar to the feeder station of the climate controlled containment unit, the feeder station 140 of the open-air containment unit 120 provides feed at a low level to simulate the game birds' natural instincts of eating in the wild. The feeder station 140 comprises an 11 inch high, 45 degree funnel 142 housed in a 3 foot by 3 foot 16-guage steel box 143 with a lid 144 having a handle 146 and a latch 147 similar to that of the lid of the climate controlled containment unit. The funnel 142 is connected to two, 3 inch diameter tubes 148 that drop down into 5 inch caps 149 from where the game birds feed. Within the open-air containment unit 120, there is also a water station. The water station comprises a water feeding tube 732 which is fed water from the sealed storage tank 330 of the climate controlled containment unit 110 using half inch tubing 334. The water feeding tube 732 is a 2 inch PVC pipe that has one or more nipples attached to it from where the game birds may drink.

FIG. 8 is a top perspective of the open-air containment unit of the propagation station, in accordance with some embodiments.

In some embodiments, the open-air containment unit 120 of the propagation station is framed with 1.5 inch square channel 16-gauge steel 810, reinforced with 0.75 inch square channel 16-gauge steel 820, and sided with 0.25 inch mesh 14-guage steel 710. The open-air containment unit 120 comprises an 18 inch hinged square door 840 having a handle and a latch (not shown). The hinged square door 840 allows access into the open-air containment unit 120 if the need so arises. Additionally, the open-air containment unit 120 has a 3 foot by 3 foot plate 850 where the feeder station 140 is attached to the open-air containment unit 120. The plate 850 has two, 3 inch openings 860 for the two, 3 inch diameter tubes 148 that drop down into the open-air containment unit 120. Within the open-air containment unit 120, there is also a water station. The water station comprises a water feeding tube 732 which is fed water from the sealed storage tank 330 of the climate controlled containment unit 110 using half inch tubing 334. The water feeding tube 732 is a 2 inch PVC pipe that has one or more nipples attached to it from where the game birds may drink.

FIG. 9 is an end perspective of the open-air containment unit of the propagation station, in accordance with some embodiments.

In some embodiments, the open-air containment unit 120 of the propagation station comprises a hinged panel door 910 sided with 0.25 inch mesh 14-guage steel 710 through which the game birds are released after the four week brooding process. The door 910 has a hinge 920 on the bottom edge and latch 930 on the top edge. The water feeding tube 732 is positioned along one of the walls of the open-air containment unit 120.

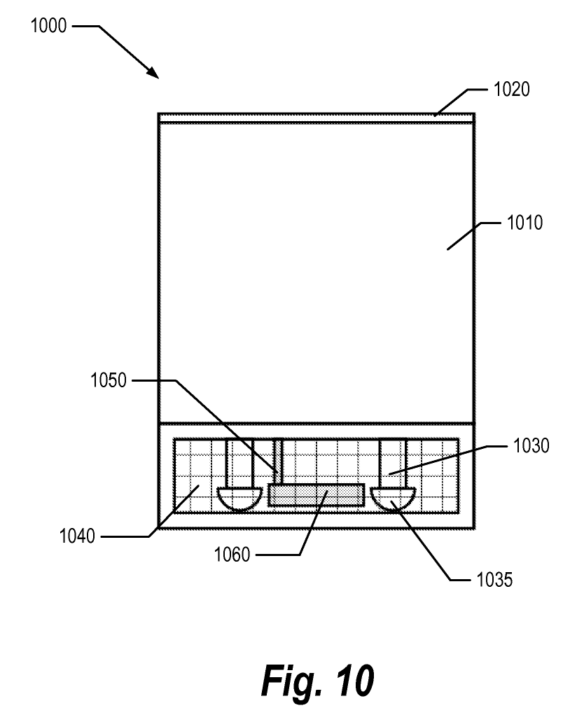

FIG. 10 is a front perspective of the feed station, in accordance with some embodiments.

In some embodiments, the game birds are released from the propagation station after the four week brooding process and the propagation station is removed and replaced with a feed station 1000. The feed station 1000 comprises a 3 foot 16-guage steel cube structure 1010 having a hinged lid 1020 and feed cylinders 1030 that drop down into 5 inch caps 1035 and extend down into a 1 foot high, 3 foot square frame sided with 4 inch by 4 inch cattle panel 1040. The cattle panel 1040 permits the game birds to access the feed while preventing other larger animals from eating the feed. There is also a water system similar to that of the propagation station. An enclosed water storage tank (not shown) is placed within the feed station 1000. Half inch tubing 1050 extends down from the water storage tank to a water feeding tube 1060. The water feeding tube 1060 is a 2 inch PVC pipe that has one or more nipples attached to it from where the game birds may drink. The feed station 1000 is similar to the feed station that the game birds used while brooding in the propagation station. The familiarity of the feeding system helps in sustaining a healthy population of the released game birds.

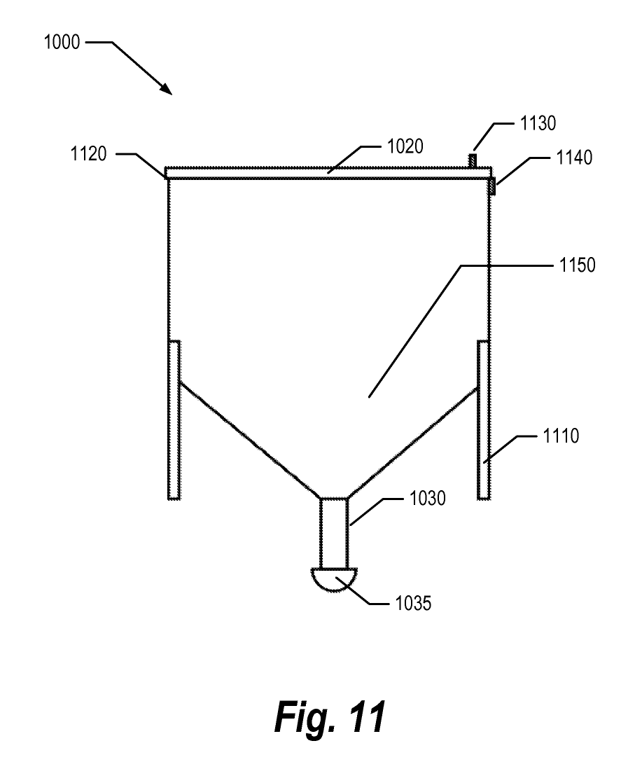

FIG. 11 is a cutaway side perspective of the feed station, in accordance with some embodiments.

In some embodiments, the feed station 1000 comprises 1.5 inch by 1.5 inch angle steel 1110 at all four corners for support and rigidity. The lid 1020 has a one inch lip over the side walls of the feed station 1000. The top of the feed station 1000 also has a one inch lip. Having these lips protects the feed from exposure to the environment and elements. The lid 1020 is hinged on one side 1120 and has a handle 1130 and a latch 1140 on the opposite side. Similar to the feeder station of the propagation station, the feed station 1000 comprises a funnel 1150 that is connected to two, 3 inch feed cylinders 1030 that drop down into 5 inch caps 1035 from where the game birds feed. The water system is not shown in this perspective.

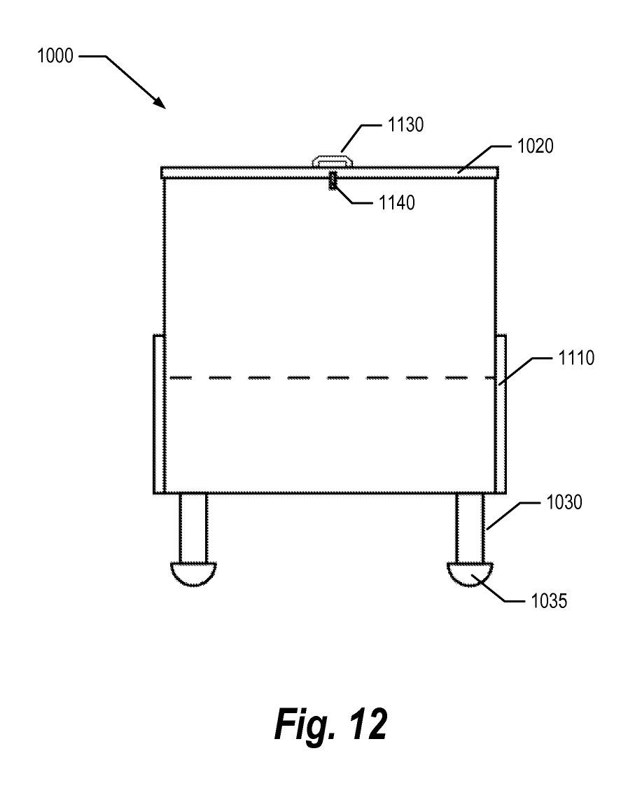

FIG. 12 is a front perspective of the feed station, in accordance with some embodiments.

In some embodiments, the feed station 1000 comprises 1.5 inch by 1.5 inch angle steel 1110 at all four corners for support and rigidity. The lid 1020 has a handle 1130 and a latch 1140. In FIG. 12, the two, 3 inch feed cylinders 1030 that drop down into 5 inch caps 1035 are shown. The water system is not shown in this perspective.

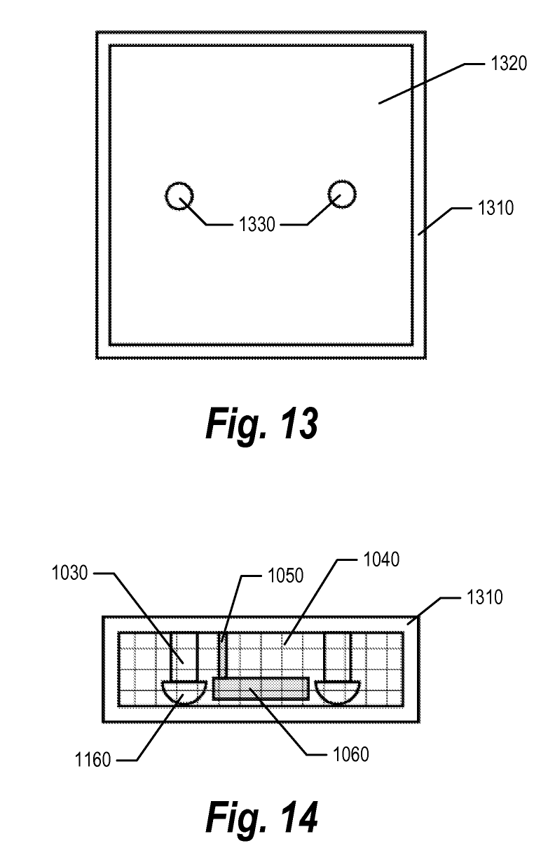

FIG. 13 is a cutaway top perspective of the feed station, in accordance with some embodiments.

In some embodiments, the feed station comprises a 3 foot square frame base constructed from 1.5 inch square channel 16-gauge steel 1310. The top of the frame is covered with a 14-guage steel sheet 1320. The sheet 1320 has two, 3 inch diameter holes 1330 where the feed cylinders 1030 extend down into the frame 1310.

FIG. 14 is a front perspective of the panels of the base of the feed station, in accordance with some embodiments.

In some embodiments, the feed station comprises a 1 foot high, 3 foot square frame constructed from 1.5 inch square channel 16-gauge steel 1310. The frame 1310 is sided on all four sides with 4 inch by 4 inch cattle panel 1040. The cattle panel 1040 surrounds the feed cylinders 1030 that drop down into 5 inch caps 1035 and protects the feed and water from larger animals while allowing access for game birds. Half inch tubing 1050 extends down from the water storage tank to a water feeding tube 1060. The water feeding tube 1060 is a 2 inch PVC pipe that has one or more nipples attached to it from where the game birds may drink.

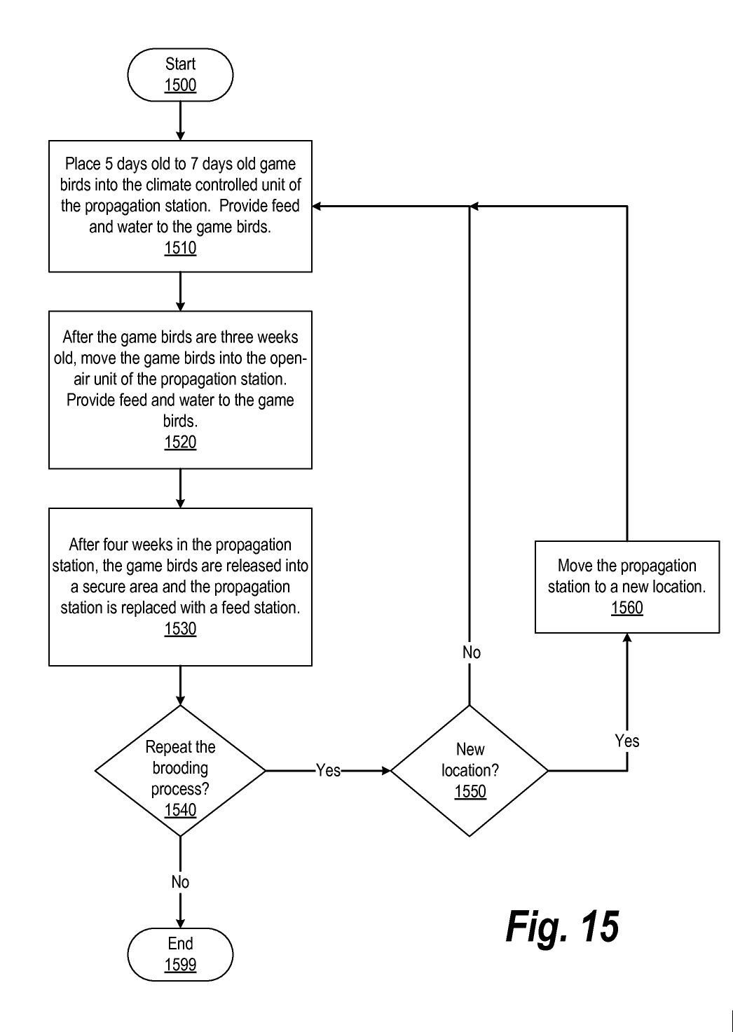

FIG. 15 is a flow diagram illustrating a method for propagating game birds, in accordance with some embodiments. In some embodiments, the method illustrated in FIG. 15 may be performed by one or more of the devices illustrated in FIGS. 1-14.

Processing begins at 1500 whereupon, at block 1510, 5 days old to 7 days old game birds are placed into the climate controlled containment unit of the propagation station. The climate controlled containment unit is maintained at a constant temperature by a propane heating system. While in the climate controlled containment unit, the game birds have access to feed and water at low levels to nourish the game birds and to simulate their natural instincts of eating in the wild. The game birds are kept in the climate controlled containment unit until the game birds are three weeks of age.

At block 1520, the game birds are moved from the climate controlled containment unit into the adjacent open-air containment unit. The open-air containment unit also has a feed and water system at low level access for the game birds. Within the open-air containment unit, the game birds begin to acclimate to their natural surroundings, but are still protected from predators by the steel mesh which form the roof, floor, and walls of the open-air containment unit. The game birds are kept in the propagation station an additional two weeks before they are released.

At block 1530, the game birds are released from the open-air containment unit of the propagation station into a secure, penned area. After release, the propagation station is removed and replaced with a feed station. The feed station is similar to the feed station of the open-air containment unit. Placing a similar feed station allows the game birds to continue their nourishment using a system that they were accustomed to during the brooding process. This increases the chances of sustaining a healthy population of game birds.

At decision 1540, a determination is made as to whether the brooding process should be repeated. If the brooding process is repeated, decision 1540 branches to the “yes” branch where, at decision 1550, a determination is made as to whether the brooding process will be repeated in the same or new location. If the brooding process is to be repeated at a new location, at block 1560, the propagation station is moved to the new location and then the process repeats back to block 1510. If the brooding process is to be repeated at the same location, processing repeats back to block 1510. If the brooding process is not repeated, decision 1540 branches to the “no” branch where processing end at 1599.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A transportable game bird brooder system comprising:
a trailer frame comprising:
a mesh flooring;
one or more wheel axles attached to the trailer frame;
two or more wheels attached to the one or more wheel axles; and
a coupler attached to the trailer frame and configured to connect the trailer frame to a trailer hitch;
a climate controlled containment unit attached to a first portion of the trailer frame, wherein the climate controlled containment unit comprises:
a lid configured to cover the top of the climate controlled containment unit;
a feeding station within the climate controlled containment unit configured to allow game bird access to feed;
a drop-in basket within the climate controlled containment unit configured to house a heating unit; and
an enclosed water system within the climate controlled containment unit configured to allow game bird access to water;
an open-air containment unit attached to a second portion of the trailer frame, wherein the open-air containment unit comprises a panel door configured to allow the release of game bird from the transportable game bird brooder system; and
wherein the climate controlled containment unit further comprises controllable game bird access to the open-air containment unit.

2. The transportable game bird brooder system of claim 1, wherein the enclosed water system comprises:
a water storage tank;
a pipe coupled to the water storage tank; and
one or more nipples coupled to the pipe.

3. The transportable game bird brooder system of claim 2, wherein the open-air containment unit further comprises a second pipe coupled to the water storage tank of the climate controlled containment unit and one or more nipples coupled to the second pipe and configured to allow game bird access to water within the open-air containment unit.

4. The transportable game bird brooder system of claim 1, wherein the open-air containment unit further comprises a second feeding station.

5. The transportable game bird brooder system of claim 1, wherein the open-air containment unit further comprises a second enclosed water system.

6. The transportable game bird brooder system of claim 1, wherein the heating unit comprises a propane heater.

7. The transportable game bird brooder system of claim 1, further comprising an external feed station wherein the external feed station comprises one or more feed caps within a cattle panel wall configured to allow game bird access to feed.

8. The transportable game bird brooder system of claim 7, wherein the external feed station further comprises one or more water nipples within the cattle panel wall.

9. A method for propagating game birds, the method comprising:
providing a transportable game bird brooder system comprising:
a trailer frame comprising:
a mesh flooring;
one or more wheel axles attached to the trailer frame;
two or more wheels attached to the one or more wheel axles; and
a coupler attached to the trailer frame and configured to connect the trailer frame to a trailer hitch;
a climate controlled containment unit attached to a first portion of the trailer frame, wherein the climate controlled containment unit comprises:
a lid configured to cover the top of the climate controlled containment unit;
a feeding station within the climate controlled containment unit configured to allow game bird access to feed;
a drop-in basket within the climate controlled containment unit configured to house a heating unit; and
an enclosed water system within the climate controlled containment unit configured to allow game bird access to water;
an open-air containment unit attached to a second portion of the trailer frame, wherein the open-air containment unit comprises a panel door configured to allow the release of game bird from the transportable game bird brooder system; and
wherein the climate controlled containment unit further comprises controllable game bird access to the open-air containment unit;
placing less than week old game birds into the climate controlled containment unit and providing the game birds feed and water for approximately two weeks;
after the game birds reach approximately three weeks old, permitting the game birds to access the open-air containment unit and providing the game birds feed and water for approximately two additional weeks; and
releasing the game birds from the transportable game bird brooder system approximately four weeks after placing the less than week old game birds into the climate controlled containment unit.

10. The method of claim 9, wherein the enclosed water system comprises:
a water storage tank;
a pipe coupled to the water storage tank; and
one or more nipples coupled to the pipe.

11. The method of claim 10, wherein the open-air containment unit further comprises a second pipe coupled to the water storage tank of the climate controlled containment unit and one or more nipples coupled to the second pipe and configured to allow game bird access to water within the open-air containment unit.

12. The method of claim 9, wherein the open-air containment unit further comprises a second feeding station.

13. The method of claim 9, wherein the open-air containment unit further comprises a second enclosed water system.

14. The method of claim 9, wherein the heating unit comprises a propane heater.

15. The method of claim 9, the method further comprising providing an external feed station wherein the external feed station comprises one or more feed caps within a cattle panel wall configured to allow game bird access to feed after the game birds have been released from the transportable game bird brooder system.

16. The method of claim 15, wherein the external feed station further comprises one or more water nipples within the cattle panel wall.
